(19) United States
(12) Patent Application Publication
(10) Pub. No.: US 2010/0133107 A1
(43) Pub. Date: Jun. 3, 2010

(54) METHOD FOR ELECTROCHEMICAL DEPOSITION OF MONOLAYERS ON METALLIC SURFACES AND OBJECTS COATED WITH AN ORGANIC MONOLAYER

(75) Inventors: Nikolay Fishelson, Lod (IL); Alexandra Inberg, Herzliya (IL); Yosi Shacham-Diamand, Zichron- Ya'acov (IL); Nathan Croitoru, Kfar Saba (IL)

Correspondence Address: OLIFF & BERRIDGE, PLC, P.O. BOX 320850, ALEXANDRIA, VA, 22320-4850, US

(73) Assignee: RAMOT AT TEL-AVIV UNIVERSITY LTD, Tel Aviv (IL)

(21) Appl. No.: 12/446,372

(22) PCT Filed: Oct. 21, 2007
(86) PCT No.: PCT/IL2007/001263

§ 371 Date: May 22, 2009

Related U.S. Application Data
(60) Provisional application No. 60/852,647, filed on Oct. 19, 2006.

(51) Int. Cl. B32B 15/04; C25D 9/02

(52) U.S. Cl. 205/50; 205/317

(57) ABSTRACT

The present invention generally provides methods for the electrodeposition of organic monolayers onto the surfaces of a great variety of objects.

### FIELD OF THE INVENTION

This invention relates to materials and methods for protecting metallic surfaces against corrosion.

### BACKGROUND OF THE INVENTION

There are many methods for protecting metals, such as those used in household and jewelry, against corrosion. Silver, for example, is a metal used in numerous products and industries such as, but not limited to, photography, tableware, ornaments, mirrors, jewelry, coins and medals, and medical products. There are numerous potential future applications in bioengineering and microelectronics as well.

Notwithstanding the above, several drawbacks make silver applications limited. One of the most important disadvantages of silver is its tendency to tarnish due to contact with sulfur-containing materials in the ambient atmosphere or in packaging. Furthermore, in high humidity or salty atmospheres the silver interaction with oxygen and/or chloride ions brings about the formation of silver oxides and/or chlorides. In some cases, the silver surface loses its luster and develops gray-black or yellow tarnish. The color of the tarnish depends on the thickness and nature of the contaminant. These qualities greatly reduce the value of products manufactured from silver. In the electrical industry, tarnishing and corrosion of silver reduces the reliability of the electrical applications (reduced conductivity) or the usability thereof in optical applications (reduced reflectivity).

Several different approaches have been employed to overcome the problems associated with silver. For example, by alloying with copper (92.5% silver and 7.5% copper), the tarnishing is reduced. Low tarnish silver alloys are further described in U.S. Pat. No. 5,882,441 and U.S. Pat. No. 5,817,195 to Davitz.

Some methods for preventing metal corrosion include insulation of unstable material in corrosive ambient metals with thin metal, inorganic or organic films. The effectiveness of this approach is based simply on the capability of such film-forming materials to create dense, hydrophobic and chemically inert structures that do not allow aggressive substances such as gaseous oxygen, nitrous oxide or hydrogen sulfide, and water to penetrate and reach the protected metal surface.

Lacquer or polymer tarnishing resistant surface coatings deposited on a silver object act as a barrier for the contact with the surrounding atmosphere. Typically, these barriers are not stable over time. Finishes to a silver surface to improve tarnish resistance are described in U.S. Pat. No. 4,006,026 to Dahms.

U.S. Pat. No. 5,728,431 to Bergbreiter et al., describes a process for forming a self-assembled monolayer (SAM) on a metallic surface for improved corrosion resistance.

WO99/48682 to Waldeck et al., describes tarnish resistant articles comprising a metallic surface, such as copper or silver coated by immersion in a bath of allkylthiol overnight to form a thin, robust self-assembled monolayer of alkylthiol on the surface. FIG. 22 of W099/48682 demonstrates that optimum coating in the bath is a function of the allkylthiol concentration and the immersion time. Too short an immersion time leads to incomplete coating and too long an immersion time leads to pinholes due to corrosion.

There is still a need to provide improved materials and methods for metal surface corrosion protection.

### SUMMARY OF THE INVENTION

The inventors of the present invention have developed a method for coating a metal surface of various articles having so-called non-uniform surface structure, such as for example, non-uniform, three-dimensional surface with restricted access and tight tolerances and cavities. Relative to known coating techniques which have the tendency to result in non-uniform thicknesses and non-uniform qualities, the method of the invention provides a uniformly thick layer having high adherence to the metal surface. As electron transfer occurs very close to the surface, i.e., within less than 100 Å, the coating produced by the method of the invention is formed by closely following the intimate structure of the surface, thereby allowing the coating of complex geometries, such as jewelry.

Additionally as will be shown, the thickness of the coating and the nature thereof is highly controllable, an advantage which allows the production of series of products of similar characteristics and qualities.

It is therefore that this invention provides methods, compositions, kits and systems for electrochemical stimulated deposition of a coating, being a monolayer of an organic molecule(s) on a metal or a metal-containing surface of an object.

Thus, in one aspect of the present invention, there is provided a method for deposition of a monolayer on a metallic surface, the method comprising:
providing a metallic surface;
contacting said metallic surface with a solution comprising (i) at least one organic compound having a surface-active group, and (ii) at least one non-gaseous oxidizing agent; and
applying a potential to said surface being in contact with said solution, e.g., said potential is selected so as to provide metal surface charging;

whereby the at least one organic compound (i.e., through its surface active group) adsorbs onto the metallic surface to provide a surface having high passivation.

The potential applied to the surface may be selected depending on the surface to be treated to be, in some embodiments, appreciably high electrode positive potential so as to make metal outer layer sufficiently positively charged and electron depleted. This promotes maximally strong adsorption, in some embodiments, in the form of a covalent interaction between said metal atoms and the atoms of the surface-active group of said organic molecule. The optimal potential may also be tuned by precise selection of the oxidizing agent or by direct external electrochemical control.

In some embodiments, the potential induced on the surface to be coated is a positive electrode potential relative to the standard hydrogen electrode potential. In some embodiments, the positive potential is at least about +0.2V. In further embodiments, the positive potential is between +0.2V and +1.5V.

The surface to be coated is typically the surface, or any part thereof, of an article, an object, an apparatus, an electrical appliance, a medical device, an optical object, a coin, a medal, an ornamental object, a piece of jewelry, a household appliance, a military device and a structure of any shape and size which is metallic, namely being made of at least one metal, an alloy thereof, an oxide thereof or containing metal at any concentration. Where the surface is not fully metallic, the metal may be the matrix wherein at least an additional material is embedded or may itself be embedded within a non-metallic matrix. Non-limiting examples of metals are copper, palladium, platinum, gold and silver or any alloys, oxides or mixtures thereof.

In some embodiments, the surface is of silver. In some other embodiments, said surface contains silver. The silver may be selected from sterling silver, silver plate and fine silver.

In the method of the invention, the surface is passivated, namely coated with a layer of molecules, thereby reducing, minimizing or preventing corrosion of said surface. As will be shown hereinbelow, employment of the method of the invention affords surfaces having high surface passivation. The extent of surface passivation is typically measured in comparison with uncoated surfaces as well as with surfaces coated by self-assembly, namely in the absence of electrochemical stimulation. The phrase “high surface passivation” or any lingual variation thereof, refers herein to the monolayer assembled in accordance with the invention characterized as having one or more of (i) a high polarization resistance, Rp, as defined hereinbelow; (ii) a low pinhole density (availability) throughout the coated surface, as defined hereinbelow; and (iii) a drop in the mean reflection of surface at a wavelength between 400 and 700 nm.

In some embodiments, the monolayer assembled in accordance with the invention has a high polarization resistance, Rp, of at least 5 kOhm·cm² where coating proceeded at a positive potential. In other embodiments, Rp is at least 8 kOhm·cm² at a positive potential. In other embodiments, Rp is at least 15 kOhm·cm² at a positive potential. In still further embodiments, Rp is between 5 and 50 kOhm·cm² at a positive potential. In comparison, self-assembled monolayers in accordance with known methods exhibited Rp values of less than 3 kOhm·cm², in some cases less than 1 kOhm·cm², as demonstrated in Table 3 below.

In some embodiments, the monolayer assembled in accordance with the invention has a pinhole density (availability over the surface), defined via peak current, Ip, employing cyclic voltammetry (CV) measurements, of less than 1.5 μA/cm² where coating proceeded at a positive potential. In other embodiments, Ip is less than 0.5 μA/cm² at a positive potential. In further embodiments, Ip is less than 0.1 μA/cm² at a positive potential. In comparison, self-assembled monolayers in accordance with known methods exhibited Ip values of more than 2 μA/cm², and in some cases more than 100 μA/cm², as demonstrated in Table 3 below.

In some embodiments, the exposition duration needed for 50% drop in the mean reflection of the coated surface (at a wavelength between 400 and 700 nm) is at least 50 hours in comparison with 0.5 hours for the uncoated surface.

The monolayer coated surface having a high surface passivation is thus, in some embodiments, a surface having (i) Rp selected from at least 5 kOhm·cm², at least 8 kOhm·cm², and at least 15 kOhm·cm²; (ii) Ip selected from less than 1.5 μA/cm², less than 0.5 μA/cm², and less than 0.1 μA/cm²; and (iii) a drop in the mean reflection of the coated surface at a wavelength between 400 and 700 nm of at least 50%.

In other embodiments, the monolayer according to the invention has (i) Rp of at least 15 kOhm·cm²; Ip of less than 0.01 mkA/cm²; and (iii) a drop in the mean reflection of the coated surface at a wavelength between 400 and 700 nm of at least 50% over a period of at least 50 hours.

In further embodiments, the monolayer according to the invention is a monolayer exemplified herein in the Tables and examples.

The at least one organic compound employed in the method of the invention is a carbon-based compound, in some embodiments being linear in structure, having at least one surface-active group preferably at one of the termini of the linear chain. Within the scope of the present invention, the “surface-active group” is an atom or a group of atoms selected to have a preferential reactivity (adsorptive) towards the surface to be treated, e.g., towards the metallic component of said surface. Such reactivity is required so as to enable bond formation between localities on the surface and the active group under the conditions employed. In some embodiments, the adsorptive interaction between the surface and the active-surface groups is covalent.

Generally, the reactivity of the surface active group towards the surface is such that bond formation between the active group and the surface will not occur under traditional self-assembly conditions but rather require the conditions employed by the present invention to proceed.

In some embodiments, the at least one organic compound is of a general formula HₙER, wherein; E is a reactive atom or a group of such atoms, R is an organic moiety selected from C₅-C₃₀alkyl, and C₆-C₁₀-aryl and wherein n is an integer from 1 to 3. The surface-active atom or group of atoms, E, is bonded to the backbone of the molecule, R, at one of its termini positions.

In some embodiments, E is an atom capable of interacting with the metallic surface, said atom being selected from oxygen, sulfur, selenium, phosphorus and nitrogen.

In other embodiments, E is a group of atoms such as a carboxylic acid (forming a metal-carboxylate species with the metal component on the surface).

In one embodiment, the at least one organic compound is a compound of general formula HₙER, wherein E is a sulfur atom, n equals 1 and R is as defined above.

As stated above, the at least one organic group is selected so as to be capable to interact with the surface and form a well-structured assembly thereon. In order to obtain such an assembly, the backbone of the organic compound(s) must be long enough and of a predetermined substitution, so that van der Waals interactions between molecules in the assembly are maximized. For this reason, R is typically selected amongst C₅-C₃₀-alkyl, and C₆-C₁₀-aryl, which may or may not be substituted. Where substitution exists, it is typically of short chain alkyl groups, having 1 or 2 carbon atoms (e.g., methyl or ethyl substitutions), substituted along the e.g., alkyl backbone in a repetitive manner. In some embodiments, R is thus an unsubstituted alkyl group. In other embodiments, R is an alkyl having at least one methyl substitutions.

As used herein, the term “alkyl” refers to an aliphatic moiety, being preferably linear and having at least 5 carbon atoms in the form of repeating methylene groups, and terminating on one end with a methyl group. According to the invention, the alkyl is substituted at the other terminus with the surface-active group, E. The general structure of such an alkyl may be HₙE-(CH₂)ₘ—CH₃, wherein n and E are as defined above and m is at least 4. As further defined above, the alkyl may be substituted by one or more methyl and/or ethyl groups. The expression “C₅-C₃₀-alkyl” refers to an alkyl having between 5 and 30 carbon atoms structured as defined.

Non-limiting examples of such alkyls are pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, and triacontyl.

In some embodiments, the alkyl is of at least 5 and at most 30 carbon atoms. In some other embodiments, the alkyl is of at least 10 and at most 24 carbon atoms. In still other embodiments, the alkyl is between 15 and 20 carbon atoms.

In some embodiments, the at least one organic compound is selected from alkyl thiol (alkyl-SH), alkyl amine (alkyl-NH₂) and alkyl phosphine (alkyl-PH₂).

In one embodiment, the at least one organic compound is an alkyl thiol.

In another embodiment, the at least one organic compound of the formula HₙE-(CH₂)ₘ—CH₃ is octadecanethiol, (HS—C₁₈H₃₇, wherein m is 17, E is S, n is 1).

In still another embodiment, the at least one organic compound is an alkyl amine or an alkyl phosphine.

In certain embodiments, the at least one organic compound is the general formula HₙER, as defined above wherein R is an alkyl chain interrupted by one or more double or triple bond. Non-limiting general examples of such groups are —CH═CH—(CH₂)ₖ—, —CH═CH—CH═CH—(CH₂)ₖ—, —CH═CH—(CH₂)ₙ—C≡C—, —C≡C—(CH₂)ₖ—, wherein k is an integer defining the number of repeating methylene groups.

Within the context of the present invention, the term “aryl” refers to an aromatic monocyclic or multicyclic group containing from 6 to 10 carbon atoms. Aryl groups include, but are not limited to unsubstituted or substituted phenyl, and unsubstituted or substituted naphthyl.

In some embodiments, the desired monolayer is of a single organic compound. In some other embodiments, the at least one organic compound is a mixture of at least two different organic compounds, preferably each of the general formula HₙER, as defined above. In some cases, the difference between the at least two organic compounds is in the surface-active groups E. In other cases, the difference between the at least two compounds is in the length, and/or backbone, and/or substitution of the R group.

For example, by mixing two different alkyl thiols in the solution, mixed monolayers of different proportions may be obtained. The relative proportion of the two functionalities in the monolayer will then depend upon several parameters, such as the mixing ratio in solution, the alkane chain lengths, the solubilities of the thiols in the solvent used, and the effect the differences in the chain may have on the ability of the surface-active groups to adsorb to the surface. As a person skilled in the art would realize, the composition of the monolayer may not be the same as in the preparation solution. In order to study the composition of the monolayer, measurements with a surface-sensitive probe like, e.g., X-ray photoelectron spectroscopy (XPS) may be employed so as to calibrate the mixing ratio.

As stated above, the method of the invention is carried out while the metallic surface is in contact with a solution comprising at least one organic compound having a surface-active group, as defined above, and at least one non-gaseous soluble oxidizing agent. The at least one non-gaseous soluble oxidizing agent is selected amongst oxidizing agents which are liquids or solids at room temperature. Oxidizing agents, which are gases at room temperature, are excluded from the scope of the present invention.

The non-gaseous soluble oxidizing agent is selected in a non-limiting fashion from ammonium peroxosulfate, iodine, cerium (IV) sulfate and nitrobenzoic acid.

In one embodiment, the oxidizing agent is nitrobenzoic acid. The solution comprising the at least one organic compound and at least one non-gaseous soluble oxidizing agent is typically an aqueous or non-aqueous liquid solution, optionally further comprising a non-aqueous solvent such as ethanol, iso-propanol, hexane and toluene. The liquid solution may further comprise at least one electrolyte such as lithium perchlorate (LiClO₄).

Additionally, where the liquid solution is non-aqueous, it may further comprise at least one polar solvent, such as acetonitrile, tetrahydrofurane, propylenecarbonate, or dimethylsulfoxide. The polar solvent is selected to allow dissociation of the salt in the solution and to make the solution conductive. In some cases, only acetonitrile is used in a concentration range of between about 5 to about 100% weight/weight.

In order to obtain a successful coating of the surface, the surface must be contacted with the above solution. As used herein, the term “contacting” or any lingual variation thereof, refers to having the surface and the solution in intimate proximity to each other. Preferably, the contacting is achieved by immersion of the surface in the solution, as disclosed.

According to some other embodiments, the contacting step induces accelerated deposition of the monolayer relative to a chemical oxidation reaction without maintaining positive electrode potential. In some cases, the reaction time to achieve 50% surface coverage of the accelerated deposition is less than 2 min. In some cases, the reaction time is less than 1 min.

Thus, according to some embodiments, the positive electrode potential is maintained over at least one minute. In some cases, the positive electrode potential is maintained over at least thirty minutes.

In some embodiments of the method of the invention, the method comprises applying a cyclic electrode potential of at least +/−0.4 mV to said metallic surface in the presence of a solution comprising the at least one organic compound and at least one non-gaseous oxidizing agent, whereby the surface-active group of said at least one organic group covalently binds to the metallic surface to form the monolayer.

In some embodiments, the cyclic electrode potential is maintained for at least 5 min. In other embodiments, the cyclic electrode potential is maintained for at least 10 minutes. The frequency of the cyclic electrode potential ranges from 0.1 to 200 Hz.

According to another aspect of the present invention, there is provided a composition for forming a monolayer coating on a surface, said composition comprising at least one source of an alkyl thiol, at least one non-gaseous oxidizing agent and at least one solvent.

In some embodiments, the composition further comprises at least one electrolyte, e.g., a salt, such as lithium chlorate, having, in some cases, a voluminous anion and at least one solvent.

Within the context of the present invention, the “monolayer” is a two-dimensional film, one molecule thick, organized, in some embodiments via covalent bonding, or assembled at an interface, e.g., the metallic surface. In some embodiments, the monolayer is assembled at an angle to the surface, wherein the molecules are held in relation to each other by van der Waals forces approximately perpendicularly to the surface. As stated hereinabove, the monolayer obtained in accordance with the method of the invention provides a high-surface passivation.

The monolayer obtained by the method of the invention is generally distinguishable from a self-assembled monolayer (SAM) in the degree of defects present in the coating and also in the degree of passivation as detailed above. Without wishing to be bound by theory, in SAMs, in similarity to the layers of the invention, each molecule comprises a “head” and “tail”, wherein the “heads” are bound to the surface and the tails extend away therefrom. A non-limiting example is a molecule comprising an alkyl chain “tail”, typically with 10-20 methylene units, with a “head” group, such as a thiol (—SH) group, the head group having a strong preferential adsorption to the surface. The thiol molecules adsorb readily from a solution onto a surface, such as a metallic surface, creating a dense monolayer with the tail group pointing outwards from the surface. However, such monolayers, formed spontaneously from a solution, often have significant areas of defects such that the metallic surface is not fully covered. As will be further demonstrated, the coatings of the invention are “substantially defectless”, meaning at least 95% of the metallic surface is covered by the monolayer. In some embodiments, at least 97% of the surface is covered, in some other embodiments at least 98% of the surface is covered by the monolayer. In some further embodiments, at least 99% of the surface is covered by the monolayer. In most embodiments, the entire surface is covered by the monolayer with few or no defects being apparent.

The present invention also provides in another of its aspects, a kit for carrying out a non-electrolytic deposition of a monolayer on a metallic surface, said kit comprising:
a solution of at least one organic compound, as defined above;
a solution of at least one non-gaseous oxidizing agent,
optionally, a container for carrying out the non-electrolytic deposition of said metallic surface;
optionally, means for mixing the two solutions in the receptacle; and
instructions of use.

The non-electrolytic deposition is carried out by first admixing the two solutions in the receptacle to yield a non-electrolytic deposition solution that comprises at least one organic compound and at least one non-gaseous soluble oxidizing agent. Next, the object having a metallic surface is inserted into said receptacle, whereby the surface-reactive groups of said organic compounds covalently bind to the metallic surface to form the monolayer thereon. The metallic surface to be coated is allowed to remain in the receptacle for a period of time sufficient to provide a monolayer coated surface.

Each of the solutions may be contained in a separate receptacle or in a single receptacle having two or more separate compartments.

In some embodiments, the kit may further comprise additional solutions, solvents, and/or additives as detailed hereinbefore.

In some embodiments of the kit for carrying out a non-electrolytic deposition, the receptacle is an electrolytic cell having an anode and a cathode connected to a power source. In such embodiments, the solutions are admixed in the electrolytic cell, the object to be coated is immersed therein, and the cell is activated for a period of time sufficient to provide an electrolytically monolayer on the surface of the object.

This invention also provides a tarnish-resistant coated object including an object; a monolayer on at least a part of a surface of the object, wherein the monolayer includes an organic thiolate, the monolayer coated object having a reflectivity of more than 40% at 700 nm after exposure of the coating to air at 200° C. for at least one hour. In some embodiments, the exposure of the coating to air is for at least one day, at least one week, or at least one month.

According to some embodiments, the monolayer coating is adapted to provide a substantially metallic luster to the object for at least one month, and sometimes for at least one year.

The object may be, as defined above, selected from any article or an apparatus such as an electrical appliance, a medical device, an optical object, a coin, a medal, an ornamental object, an a piece of jewelry, a household appliance, and a military device. The object may contain sterling silver or may include silver plate.

In some cases, the object includes is made of fine silver (100% silver).

The invention also provides a tarnish-resistant coated metallic object including; a metallic object, an organic monolayer coating on at least a part of a surface of the object, wherein the metallic object has a substantially constant reflectivity of more than 90% at 500 nm after exposure of the coated object to ambient air for a time period of at least one week. In some embodiments, the time period is at least one month, and in others, the time period is at least one year.

The invention is further directed to a keep-clean coated piece of jewelry including; a piece of jewelry; an organic monolayer coating on at least part of the surface of the piece of jewelry, wherein the monolayer coating is adapted to prevent discoloration of the piece of jewelry after exposure of the coated piece of jewelry to ambient air for a time period of at least one week. In some embodiments, the time period is at least one month, and in others, the time period is at least one year.

The keep-clean coated piece of jewelry includes, in some embodiments silver. In some further embodiments, the silver is sterling silver, in others, the silver includes silver plate. In other embodiments, the silver is fine silver (100% silver).

The invention further provides to a water-wear piece of silver jewelry including; a piece of silver jewelry; an organic monolayer coating on the piece of silver jewelry, wherein the monolayer coating is adapted to prevent discoloration of the water-wear piece of jewelry after exposure to water after a time period of at least one week. In some embodiments, the time period is at least one month and sometimes at least one year.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic simplified flowchart for anodic deposition of a monolayer in accordance with some embodiments of the present invention;

FIG. 2 is a schematic simplified flowchart for non-electrolytic deposition of a monolayer in accordance with some embodiments of the present invention;

FIG. 3 is a schematic simplified flowchart for controlled anodic deposition of a monolayer in accordance with some embodiments of the present invention;

FIG. 4 is a schematic simplified illustration of a system for anodic deposition of a monolayer in accordance with some embodiments of the present invention;

FIG. 5 is a schematic simplified illustration of another system for anodic deposition of a monolayer in accordance with some embodiments of the present invention;

FIG. 6 is a schematic simplified illustration of a system for non-electrolytic deposition of a monolayer in accordance with some embodiments of the present invention;

FIG. 7 is a schematic simplified illustration of a controlled system for anodic deposition of a monolayer in accordance with some embodiments of the present invention;

FIG. 8A is a schematic simplified illustration of a kit for anodic deposition of a monolayer in accordance with some embodiments of the present invention;

FIG. 8B is a schematic simplified illustration of a set of instructions of the kit of FIG. 8A;

FIG. 9 is a schematic simplified illustration of a flowchart of a method for anodic deposition of a monolayer using the kit of FIG. 8A;

FIG. 10 is a schematic simplified illustration of a kit for anodic deposition of a monolayer in accordance with some embodiments of the present invention; and

FIG. 11 is a schematic simplified illustration of a flowchart of a method for anodic deposition of a monolayer in accordance with some embodiments of the present invention.

### DETAILED DESCRIPTION OF EXEMPLARY EMBODIMENTS

The method of the invention typically proceeds under conditions in which a positive electrode potential is maintained on the surface of an object while the surface is contacted with the reaction solution comprising (a) at least one organic compound having an active group and (b) at least one non-gaseous soluble oxidizing agent, whereby the at least one active group, such as a thiol, covalently binds (adsorbs) to the metallic surface of the object to form a metal alkyl thiolate, for example, organized as a dense monolayer on the surface of the object.

This process strategy leads to good coverage of the object with the monolayer, and to a significant reduction of defects in the monolayer, which, in turn provides for better protection of the object from corrosion, tarnishing and other oxidation processes. Furthermore, it has been found that the monolayer formed from a plating solution is even less defective, relative to non-controlled processes, under electrolytic deposition with induced potential (voltage) cycling.

In some embodiments of the invention, the surface to be coated is silver or containing silver. While certain embodiments of the invention will now be described relating to the coating of silver surfaces, it should be understood that the method of the invention are perfectly suitable for the coating of other surfaces made of or containing other metals.

Additionally, it should be understood that the following detailed embodiments are provided so as to allow better understanding of the novel and inventive technology. Where applicable, certain background aspects of the invention are provided. These background aspects are by no means taken to encompass any aspect of the claimed invention and are provided with no intention of being bound thereto by one or more theory or class of thought.

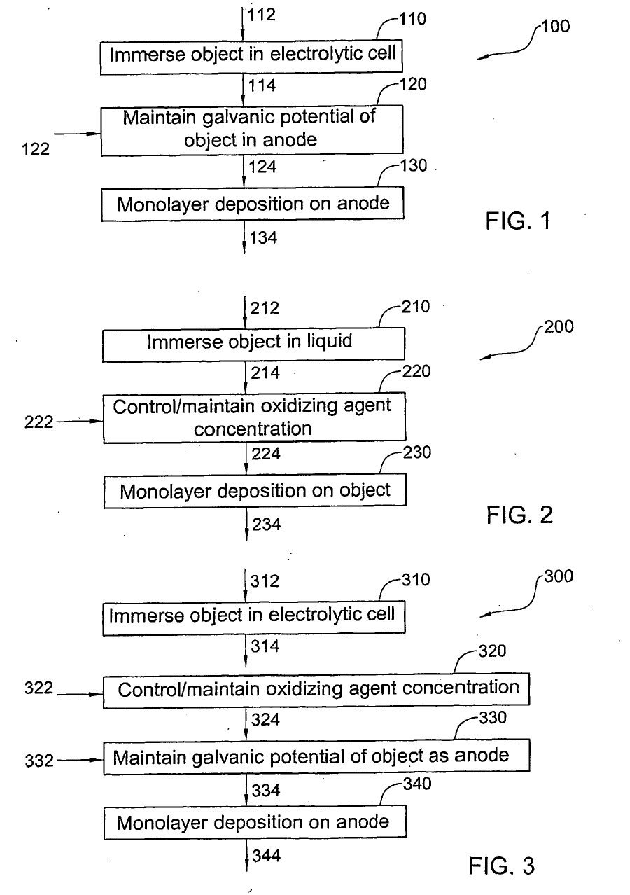

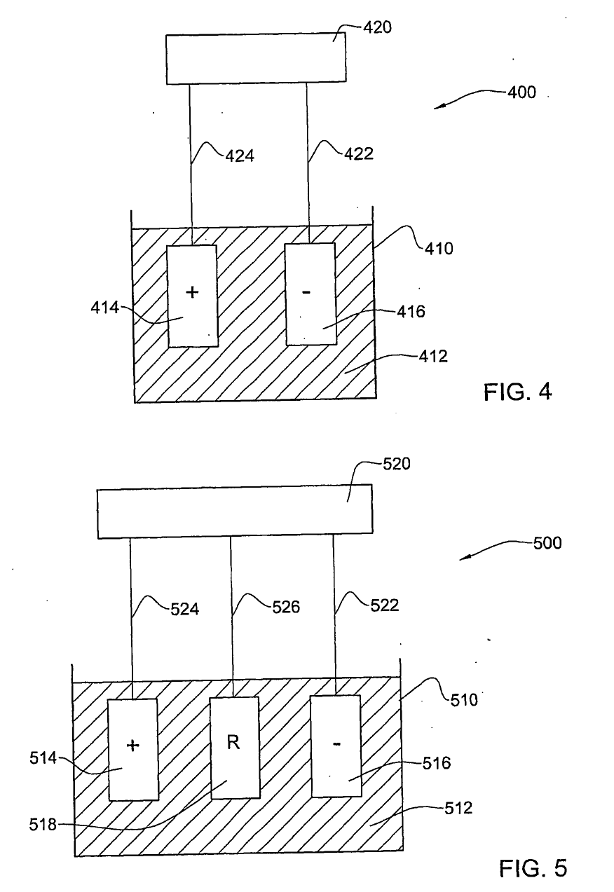

Reference is now made to FIG. 1, which is a schematic simplified flowchart 100 for anodic deposition of a monolayer onto a metallic surface of an object. In an immersing step 110, an object 112 is immersed in a liquid, such as the solution of Table 1, in an electrolytic cell to yield a wetted object 114. The cell, in some cases, may be similar or identical to any of the cells shown in FIGS. 4, 5, 7, 8A and 10. The liquid may be aqueous or non-aqueous. The object is typically oriented so as to act as the anode or part of the anode of the cell (see further details hereinbelow with reference to FIGS. 4, 5, 7, 8A and 10).

Examples of aqueous solutions include, by volume: up to around 50% water, up to around 50% ethanol, 0.05% dodecanethiol, and 0.1% nitrobenzoic acid.

Examples of non-aqueous solutions include a) the solution of Table 1 and b) 0.1% octadecanethiol, 0.1% cerium (IV) sulfate in absolute ethanol.

TABLE 1
Typical concentration ranges of components in a
monolayer electrolytic plating solution

| Component | Concentration range g/L |
|---|---|
| octadecanethiol | 0.001-10 |
| acetonitrile (by vol.) | 10-100 (ml) |
| LiClO₄ | 0.001-10 |
| absolute ethanol | 0-90 (ml) |

In some cases, the step of immersing the object in the solution induces completion of the electrolytic/electrochemical cell circuit. The immersing step typically induces one or more chemical reactions on the surface of the object.

The reaction relating to a monolayer formation is, for example, but not limited to, a pure metal surface occurring at the anode, as may be presented in the following general form:

M+HₙE-R=MeE-R+nH⁺+ne⁻, (Reaction 1)

wherein M=metal, n=1 to 3; E is the surface-active group of a SAM-forming molecule; and R designates an alkyl or aromatic radical. For example, in case of thiols, n=1, E is a sulfur atom, and Reaction 1 may be rewritten as Reaction 2:

M+HS—R=MeS-R+H⁺+e (Reaction 2)

Reactions such as (1) and (2) are electrochemical in nature and may be controlled by metal electrode potential. It has been found that thiol adsorption to the metallic surface takes place when the electrode potential is sufficiently positive. If the electrode potential is negative (cathodic), adsorption will not occur from a thiol solution, but thiolate desorption from metal surface may occur from the metallic surface, coated with thiol and exposed to solution. Exact potential values of maximal adsorption and onset of desorption depends on thiol nature. For example, for octadecanethiol, HS—C₁₈H₃₇, on silver, it was found that the critical potential for monolayer deposition and for monolayer dissolution was +0.45V and −0.85V with respect to standard hydrogen electrode, respectively.

Thereafter, in an electrode potential maintaining step, 120, a defined electrode potential between the anode and cathode is maintained for a period of time so as to induct the directionality of the chemical reactions occurring in the liquid and at the anode and cathode. Typically, this will induce the deposition of the monolayer at the anode over the period of time on the wetted object 114 to form an at least partially monolayer-covered object 124.

In some instances, the method for setting the electrode potential at a desired value is by means of controlling the electrode potential by a potentiostat (FIG. 4 hereinbelow). Additional potential 122 may be provided by means of the potentiostat to the anode.

In other embodiments, one or more oxidizing agents, 222 are added to the working solution (FIG. 2 hereinbelow), Ox, so that oxidation Reaction 2 is complemented by the reduction reaction of the oxidizing agent, as shown in Reaction 3:

Ox+nH⁺+ne⁻=OxHₙ (Reaction 3)

Oxidizing agent species work here as depolarizers, known, e.g., in corrosion science, as withdrawing electrons received from oxidized metal, which serves at the same time as neutral electron conductors, intermediating an overall electrochemical reaction. In such a case it is said also that two conjugated (coupled) reactions take place on metal electrode surfaces and they determine (metal electrode's) certain mixed (compromised) potential, whose value depends again both on half reaction reversible potentials and kinetics.

In some embodiments, the galvanic potential is maintained by an electronic device such as potentiostat, using 3-electrode scheme, such as is depicted in FIG. 5 hereinbelow, in which the thiolated article performs the function of a working electrode (anode) whose potential is controlled with respect to a reference electrode with the help of a counter electrode.

In some embodiments, a combination of a) controlling the oxidizing agent concentration in the liquid and b) the electrode potential of the anode by the potentiostat is used to maintain the galvanic potential of the anode over a period of time.

Thus, the monolayer deposition step 130 may occur simultaneously with step 120 or lag behind step 120 such that a monolayer will be deposited on object 114 to result in a monolayer-covered object 134. In some embodiments, the monolayer deposition is a first order reaction, the rate of which is a function of the oxidizing agent concentration and galvanic potential, and surface area of the object to be covered. Typically, the reaction will have an exponential phase until the rate of deposition tallies off and saturation occurs, when the entire surface is covered by a monolayer. The electrochemical systems described hereinbelow require that the liquid solution be (ionically) conductive or, in other words, the solution must be an electrolyte. A general scheme of a 3-electrode setup-electrochemical system is provided in FIG. 5 hereinbelow.

The resultant monolayer coated object 134 typically comprises a substantially continuous monolayer, as defined above.

The invention discloses a monolayer, the formation rate and quality thereof, as measured by the lack of defects of the monolayer depend on the electrode/galvanic potential of the surface. The latter may be controlled at optimal value externally (electrochemically) or by keeping the concentration of a specially chosen oxidizing agent in a thiolation solution at a certain concentration.

In confirmation of the understanding of the mechanism of the thiolation process, it was found that addition of a strong reducing agent, such as lithium borohydride, (LiBH₄) to a deaerated thiolation solution results in desorption of previously deposited monolayers, showing that the deposition of the monolayer is reversible and depends upon the electrode potential, such that a negative potential induces desorption of the monolayer from the surface.

The nature of oxidizing agent is of primary importance. The oxidizing agent may partially or fully change the electrode potential and may thus govern the rate and direction of the reaction(s) occurring at the anode/cathode. Another requirement of the oxidizing agent chosen is that it should not oxidize (and, correspondingly, be reducible by) the monolayer precursor present in solution but, at the same time, should readily be reducible electrochemically at the electrode surface.

In the prior art, it has been shown that by immersing a metallic object in a SAM precursor solution, the object may be covered by the SAM. This may be performed under ambient conditions such that the working solutions contain dissolved oxygen at arbitrary concentrations, which may, in turn, direct the reaction direction and reaction rate accordingly. Saturation of the working solution with oxygen from air provides sufficiently good conditions for thiol SAM generation, so that comparatively dense SAMs may be obtained after 10 to 30 min metal substrate exposure to thiol containing solution. With oxygen, reaction τ (3) may be written as shown in Reaction 4:

O₂+4H⁺+4e⁻=2H₂O (Reaction 4)

However, ambient oxygen from air has several disadvantages because it oxidizes the thiol molecules in monolayer precursor solutions, resulting in insoluble disulfides in most solvents. Another disadvantage of oxygen is that its reduction kinetics on metal electrodes is too slow so that actual compromise (mixed) potential of thiolation with oxygen as oxidizer is found to be not positive (anodic) enough to ensure the best conditions for thiol oxidative adsorption on the metal surface. Thus, it has been found in the present invention that oxidizing agent type and control of its concentration is critical for ensuring substantially defectless monolayer deposition.

Furthermore, it has been found also that by employing external electrochemical control, with no reaction except that of the thiol chemisorption (2) occurring on a metal electrode, a maximally ordered thiol monolayer structure is obtained with far less defects in comparison to those obtained using spontaneous deposition in the presence of air or oxygen. This is because in this case the entire surface of the metal under thiolation is available only for main Reaction 2, the auxiliary Reaction 4 being “removed” to the specially arranged counter electrode. In comparison, in case of chemical control, the same surface of single thiolated electrode should be shared between main and auxiliary Reaction 2 and Reaction 4, so that, being conjugated, the main Reaction 2 exponentially slows down because of still smaller, in the course of the process, room remaining for the Reaction 4.

In addition to electrochemical control, effectiveness in monolayer defectless structure formation has found that yet more perfect and defectless and, thereby, more protective against corrosion, monolayers may be deposited employing potential cycling in a specific range of electrode potential. This potential cycling may be accomplished both in monolayer deposition (containing monolayer precursors) solution, while deposition, and in pure solvent or in an aqueous electrolyte not containing the monolayer precursor molecules. In both cases, employing potential cycling, a considerable monolayer densification and defect healing is achieved, although potential cycling in the presence of monolayer precursors was found to be most effective.

This invention relates to covering metallic surfaces comprising any one or more of the following metals, such as, but not limited to, copper, silver, gold, palladium, rhenium, platinum, ruthenium and osmium.

This invention also encompasses many monolayers generating materials such as, but not limited to: thiols, amines, phosphines and carbonic acids. Some potential cycling regimes include, but are not limited to potential cycling from −0.4 to 0.8V with respect to standard hydrogen electrode with cycling frequency within 1 to 1000 Hz.

In the non-limiting examples hereinbelow, alkanethiol-derived monolayer is deposited onto polycrystalline silver.

Reference is now made to FIG. 2, which is a schematic simplified flowchart 200 for a non-electrolytic deposition of a monolayer in accordance with some embodiments of the present invention.

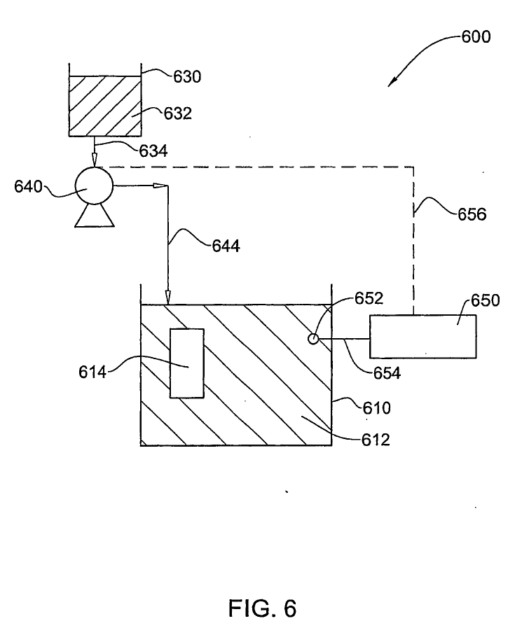

In an immersing step 210, an object 212 is immersed in a liquid, such as solution of Table 2 in a non-electrolytic cell to form a wetted object 214. The cell, in some cases, may be similar or identical to the cell of FIG. 6. The liquid may be aqueous or non-aqueous.

TABLE 2
Typical concentration ranges of components in a
monolayer non-electrolytic plating solution.

| Component | Concentration range g/L |
|---|---|
| Octadecanethiol/other* | 0.001-10 |
| Oxidizing agent# | 0.001-10 |
| Ethanol | 100 (solvent) |
| Water | 0-10 |

*The octadecanethiol can be replaced by hexadecanethiol, or biphenylpropylthiol.
#The oxidizing agent may be selected from iodine, nitrobenzoic acid, cerium (IV) sulfate, ammonium peroxosulfate.

In a maintaining step 220, the concentration of one or more oxidizing agent(s) 222 in the solution is maintained and/or controlled over a period of time. The wetted object undergoes non-electrolytic coating with one or more monolayers to form a partially monolayer coated object 224 and with time undergoes further monolayer coating until a fully coated object 234 is obtained.

In some embodiments, a combination of the control of the electrode potential and of the oxidizing agent(s) can be performed in series/parallel. For example, FIG. 3 depicts a schematic simplified flowchart 300 for controlled anodic deposition of a monolayer.

In an immersing step 310, an object 312 is immersed in a liquid in an electrolytic cell to form a wetted object 314. The cell, in some cases, may be similar or identical to the cell of shown in FIGS. 4, 5, 7, 8A and 10. The liquid may be aqueous or non-aqueous.

In a first maintaining step 320, the concentration of one or more oxidizing agent(s) 322 in the solution is maintained and/or controlled over a period of time. The wetted object undergoes at least one of non-electrolytic and electrolytic coating with one or more monolayers to form a partially monolayer coated object 324.

In another maintaining step 330, the electrode potential of the anode is maintained by setting the electrode potential at a desired value and by means controlling the electrode potential by a potentiostat (FIG. 4 hereinbelow). Additional potential 332 may be provided by means of the potentiostat to the anode. The coated object 324 undergoes further coating to form coated object 334. After a period of time coated object 334 becomes fully coated object 344. It should be understood that steps 320, 330 and 340 may be parallel, overlapping or in series and that the order of steps 320/330 may be reversed.

Reference is now made to FIG. 4, which depicts a system 400 for anodic deposition of a monolayer in accordance with some embodiments of the present invention.

System 400 comprises an electrochemical cell 410 comprising a liquid solution 412, an anode 414 and a cathode 416. Anode 414 is in electrical communication via wire 424 with a means for controlling electrode potential such as a potentiostat 420. Potentiostat 420 is in electrical communication with cathode 416 via a second wire 422.

System 400 comprises the electrochemical cell 410, which is configured and operative to electrolytically/electrochemically deposit a monolayer onto the surface of an object/anode 414.

Liquid solution 412 is, for example, but not limited to, the plating solution of Table 1.

Reference is now made to FIG. 5, which is a schematic simplified illustration of another system 500 for anodic deposition of a monolayer in accordance with some embodiments of the present invention;

System 500 comprises an electrochemical cell 510, which is configured and operative to electrolytically/electrochemically deposit a monolayer onto the surface of an object/anode 514. The cell comprises a liquid solution 512, an anode 514, a reference electrode 518 and a cathode 516. Anode 514 is in electrical communication via wire 524 with a means for controlling electrode potential such as a potentiostat 520. Potentiostat 520 is also in electrical communication with cathode 516 via a second wire 522 and with reference electrode 518 via a third wire 526.

Liquid solution 512 is, for example, but not limited to, the plating solution of Table 1.

One example of a system 600 for non-electrolytic deposition of a monolayer is provided in FIG. 6. Typically, the system is a non-electrolytic deposition of a monolayer.

System 600 comprises a non-electrolytic cell 610 comprising a liquid solution 612. At least one object 614 is immersed in the liquid solution 612, such as, but not limited to, the solution of Table 2. The system further comprises a monitoring apparatus 650 and associates at least one probe 652. The at least one probe is in electrical communication with apparatus 650, typically via a connection 654. In some cases, the connection is wired, in other cases, unwired. In some further cases, the connection may comprise both wired and unwired elements.

Apparatus 650 is configured and operative to measure at least one parameter pertaining to the liquid solution, such as, but not limited to: pH, temperature, oxidizing agent concentration, reducing agent concentration, monolayer precursor concentration and electrical parameters, such as electrode potential at the surface of the object.

Responsive to measurement of one or more of the solution parameters, apparatus 650 may send at least one signal via connection 656 to activate/stop pump 640. The pump is in liquid communication via conduit 634 with holding tank 630 holding a solution 632. This solution may be selected from, but not limited to, a pH adjuster solution, such as a base or acid solution, a monolayer precursor solution, an oxidizing agent solution, and a reducing agent solution.

In some embodiments, system 600 is used to non-electrolytically deposit monolayer on the surface of objects employing a liquid non-electrolytic solution, such as plating solution of Table 2.

It should be understood that there may be more than one pump and holding tank which corresponds to more than one solution for addition in cell 610 and that apparatus 650 may comprise more than one probe and analysis systems.

Typically, the object will be plated with a monolayer from solution 612. The deposition rate of the monolayer is a function of the monolayer precursor concentration, the electrode potential with respect to standard reference, the temperature of the solution, and the oxidizing agent concentration.

In some embodiments, apparatus 650 is configured and operative to continuously measure the one or more parameters and to send out signals to the pump(s) in response to the measured parameter(s) so as to control and/or maintain the oxidizing agent concentration. The oxidizing agent may be selected from, but limited to, iodine, nitrobenzoic acid, cerium (IV) sulfate and ammonium peroxosulfate.

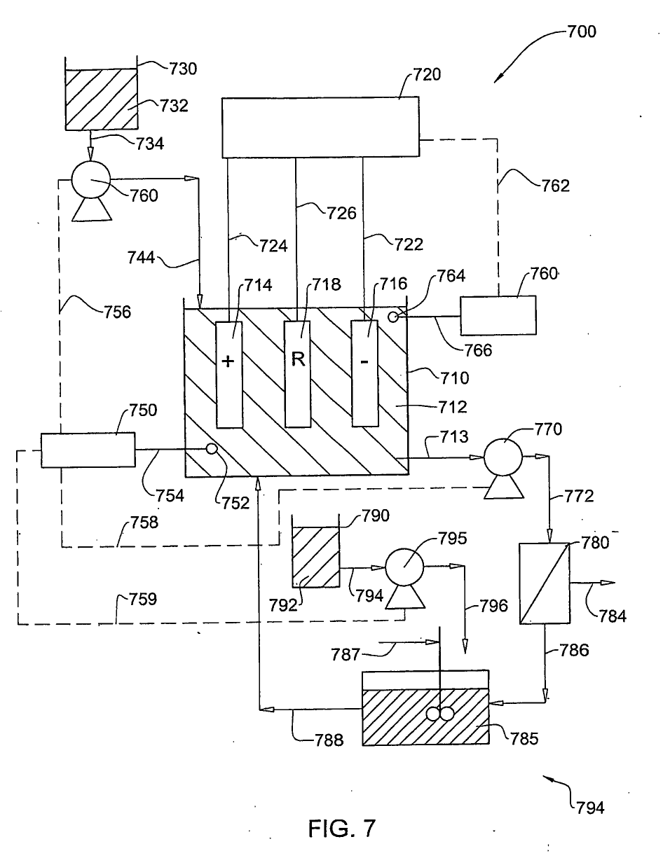

Reference is now made to FIG. 7, which is a schematic simplified illustration of a controlled system 700 for anodic deposition of a monolayer in accordance with some embodiments of the present invention.

System 700 comprises an electrochemical cell 710, which is configured and operative to electrolytically/electrochemically deposit a monolayer onto the surface of an object/anode 714. The cell comprises a liquid solution 712, an anode 714, a reference electrode 718 and a cathode 716. Anode 714 is in electrical communication via wire 724 with a means for controlling electrode potential such as a potentiostat 720. Potentiostat 720 is also in electrical communication with cathode 716 via a second wire 722 and with reference electrode 718 via a third wire 726.

Liquid solution 512 is for example, but not limited to, the solution of Table 1.

Apparatus 750 is configured and operative to measure at least one parameter pertaining to the liquid solution, such as, but not limited to: pH, temperature, oxidizing agent concentration, reducing agent concentration, monolayer precursor concentration and electrical parameters, such as electrode potential at the surface of the object.

Responsive to measurement of one or more of the solution parameters, apparatus 750 may send at least one signal via connection 756 to activate/stop pump 740. The pump is in liquid communication via conduit 734 with holding tank 730 holding a solution 732. This solution may be selected from, but not limited to, a pH adjuster solution, such as a base or acid solution, a monolayer precursor solution, an oxidizing agent solution and a reducing agent solution.

In some embodiments, apparatus 750 is configured and operative to continuously measure the one or more parameters and to send out signals to the pump(s) in response to the measured parameter(s) so as to control and/or maintain the oxidizing agent concentration. The oxidizing agent may be selected from any of the oxidizing agents listed hereinabove.

In some embodiments, system 700 further comprises another apparatus 760 for measuring at least one electrical parameter of solution, or of any one or more of the electrodes 714, 716, 718. Responsive to a measurement, apparatus 760 is configured and operative to send out at least one signal to potentiostat 720. For example, the apparatus may send out a signal to increase the electrode potential of the anode.

In some embodiments, system 700 further comprises a solution filtration and replenishing apparatus 799. Apparatus 799 typically comprises a pump 770 for removing some of the solution from cell 710 via a conduit 713. Pump 770 feeds the solution via conduit 772 to a separation apparatus 780. Separation apparatus is configured and operative to filter out/separate particles from the solution, such as monolayer residues or SAM precursor polymerization products in stream 784. For example, apparatus 780 may comprise a 0.2 micron filter such that stream 786 is substantially free of particles and globules that have an effective diameter of more than 0.2 microns.

In some embodiments, stream 786 is returned directly (not shown) to cell 710. In some other embodiments, stream 786 is collected in a tank 783 having a stirrer 787 and is mixed with stream 796. Stream 796 typically comprises one or more additives or replenishers for replenishing liquid 712.

In some cases apparatus 750 and/or apparatus 760 is/are configured and operative to measure at least parameter of liquid 712. For example, if the pH of liquid 712 has moved beyond a predefined control limit, a pH adjuster may be relayed from a tank 792 via stream 794, pump 795 and stream 796. In other cases tank 792 may comprise a replenisher, such as a concentrate of the plating solution or a source of an oxidizing agent.

It should be understood that there may be one or more such replenishing apparatuses 799, each of which is adapted to replenish a different component or parameter of liquid 712.

Though not shown in FIG. 6, the replenishing apparatus 799 or number of apparatuses may be used in connection with a non-electrolytic system, such as system 600 to replenish a different component or parameter of liquid 612.

The one or more replenisher solutions extend the working time of liquid 712 and/or liquid 612.

The separation apparatus 780 may be any filtration or centrifugation or settling apparatus known in the art for separation of solid particles and/or fat/oil particles/globules from liquid 712.

Separation apparatus 780 may be controlled and activated by any one or more of apparatus 760 and apparatus 750.

Liquid 712 is for example, but not limited to, the plating solution of Table 1.

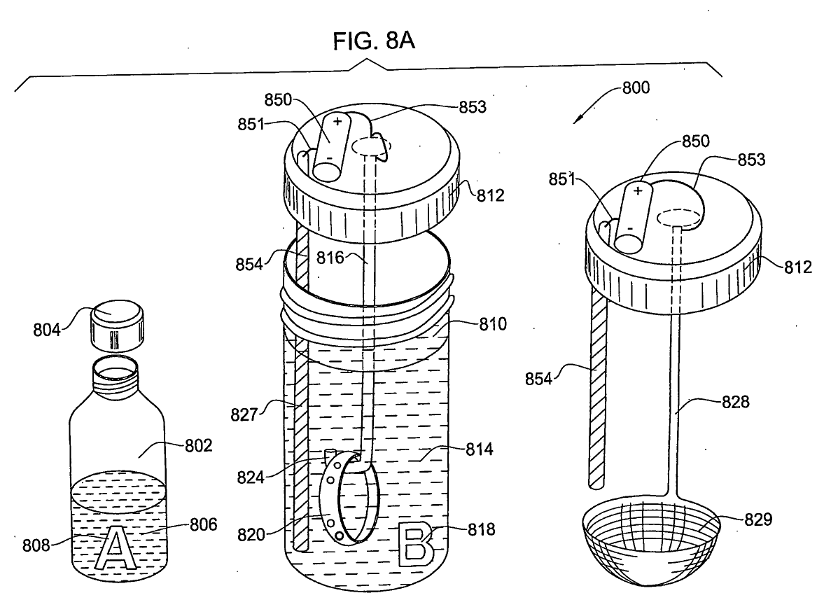

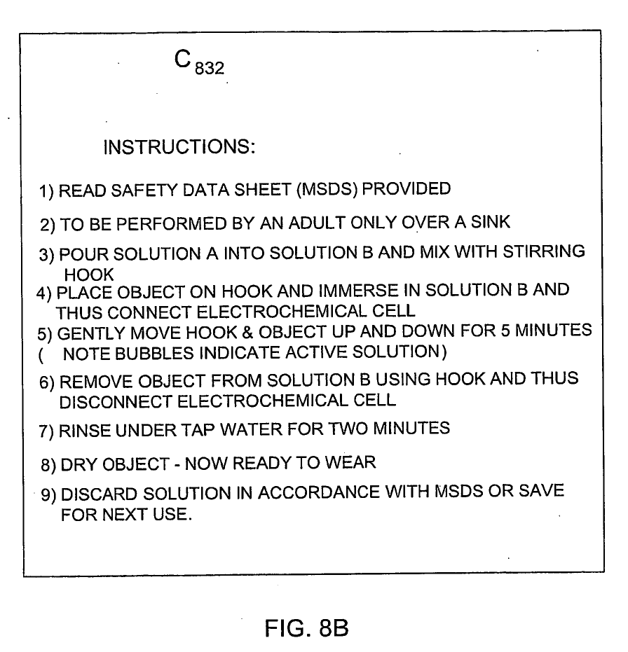

Reference is now made to FIG. 8A, which is a schematic simplified illustration of a kit 800 for anodic deposition of a monolayer in accordance with some embodiments of the present invention.

In some embodiments, non-electrolytic kits are provided, similar or identical in construction to kits 400 and 600 of WO 2005/075703 to the same Applicant, but containing a solution A (a concentrated oxidizing agent solution such as at four times the concentration of the agents listed above in Table 2 in the same solvents) and a solution B (the solution of Table 2 without the oxidizing agent), Per the monolayer plating solutions of the present invention:

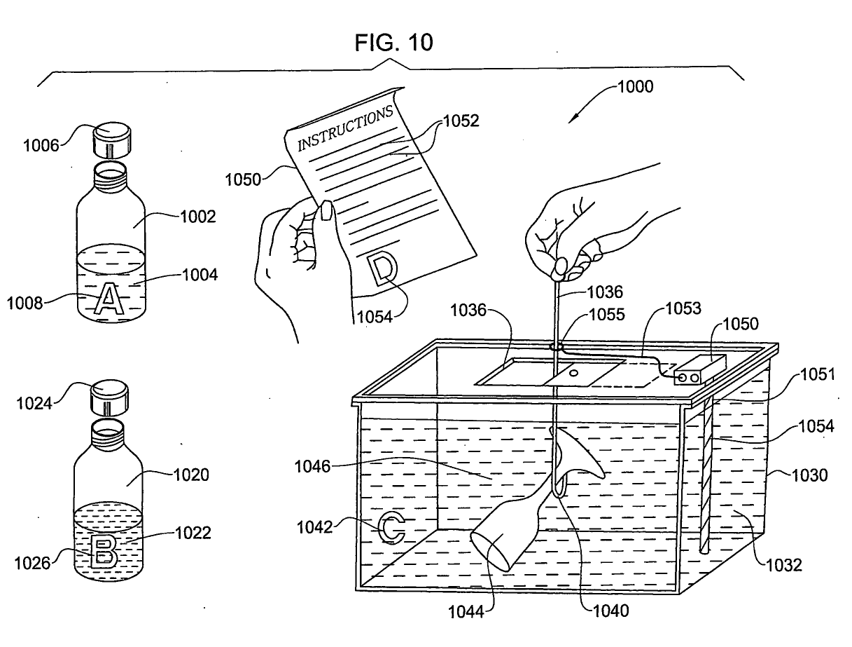

In some further embodiments, the kits are electrolytic kits 800, shown in FIGS. 8A and 1000, of FIG. 10 of the present invention.

Kit 800 is for use in plating one or more small objects and typically comprises a first container 802 with a lid 804.

The first container 802 is optional and typically contains a concentrated oxidizing agent solution 806, such as at four times the concentration of the agents listed above in Table 2 and is labeled with a number or letter 808.

The first container 802 is typically a bottle, flask, vial, vessel or the like. The solution may also comprise additives to enhance the activity of the electrolytic plating solution, such as surfactants, and stabilizers known in the art. These additives are typically at concentrations of 3-5 times those described in commercial solutions.

Container 802 is typically opaque and is may be made, for example, of colored glass, Teflon®, or polypropylene.

Kit 800 further comprises a second container 810 with a screwable lid 812. Container 810 contains a second aqueous liquid/non aqueous liquid, such as the solution of Table 1 above 814 and is labeled with a number or letter 818. Lid 812 typically comprises a pole 816, which descends from its lower surface center in parallel and central to the wall of (typically opaque) container 810.

In lid 812 is mounted an electrical power source 850, such as a battery. The battery is connected to pole 816 via wire 853, such that pole 816 acts as the anode. The battery is also in electrical communication via wire 851 with a second pole 854, which acts as the cathode.

This kind of arrangement is similar to a child's blow-soap-bubble container. Pole 816 has a hook 824 at its lower end for holding an object 820 centrally in container 810 of liquid 814. Container 810 is typically two to five times the size of container 802.

In an alternative embodiment, a lid 826, substantially identical to lid 812 has a pole 828 with a sieve 829 at its lower end. The sieve is designed, for example, to hold a number of small objects and/or one or more chains or necklaces.

Containers 802, 810 and lids 812, 816 are typically made of non-metallic materials, such as, but not limited to, plastic, colored glass, Teflon®, or polypropylene. In contrast, poles 816, 828, hook 824 and sieve 829 are all made of semiconducting/conducting materials such as, but not limited to copper or carbon.

Upon connecting pole 854 to wire 851, the circuit of the electrolytic cell is completed. This may occur upon screwing the lid onto container 814. Kit 800 further contains an instruction sheet 830 (FIG. 8B), labeled with a number or letter 832. Instruction sheet 830 provides a simple user-friendly set of instructions 834 on how to utilize the kit.

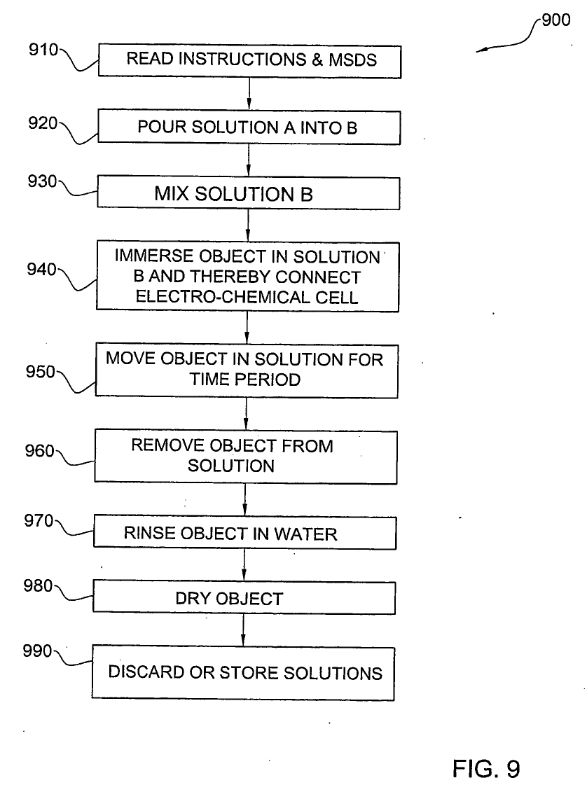

Reference is now made to FIG. 9, which is a flowchart 900 describing the method of employment of the kit of FIGS. 8A and 8B in the steps of electrolytically plating of monolayer on one or more small objects.

In a first step 910, an operator is instructed to read the instructions 834 appearing on the instructions sheet 830. The operator is also instructed to read the MSDS (manufacturer's safety data sheet), not shown.

Instructions 834 comprise simple step-by-step directions on how to electrolytically plate one or more small objects with monolayers.

In a second step 920, the operator pours some or all of solution “A”, 806 into solution “B”, 814. Preferably, both the solutions are used only for one plating process.

Alternatively, a proportion of solution A may be retained for one or more additional uses. Container 802 and container 810 may comprise graduated markings for this purpose (not shown). The final concentration of the resultant solution is typically similar or identical to the compositions disclosed in Tables 1-2.

In a mixing step, 930, the operator mixes the solution in container 810 (comprising both solution 806 and 814 in a known ratio).

Thereafter, the operator places an object on hook 824 or in sieve 829 and immerses the object on the hook/in the sieve into the mixed solution in container 810. The mixed solution is typically at room temperature 20-30° C., though this process may be operative at 0-50° C.

The pH of the mixed solution is typically 9-11, but the solution is normally operative in a pH range of 8-13, though the reaction rate will vary.

In a deposition step, 950, the operator moves lid 912, and hence rods/poles, 816, 854 and hook 824 holds the object 820 gently up and down and/or backwards and forwards for a time period. The time period is typically provided in the instructions for a fixed time at room temperature, such as ten minutes. Additionally or alternatively, the instructions may comprise a look-up table, which correlates the deposition time to the process temperature. Bubbles 822 (typically of hydrogen) are indicative that object 820 is being plated by the solution in container 810.

Furthermore, the instructions may provide a rough guide or look-up table for the time required for complete plating of the object with monolayer, as a function of the surface area of object 820. For example, the surface area [cm²] of a ring can be calculated to be approximately 4IIrh, where r is the radius of the ring and h is the height.

At the end of the given time period, the operator lifts lid 812 vertically and hence removes object 820 from the solution in a removing step 960.

Thereafter, in a rinsing step 970, the operator rinses the object under running tap water. Additionally or alternatively, the rinsing step may comprise dipping the object in a container of water.

In a drying step 980, the operator dries the object with a cloth. Alternatively, the operator leaves the object to dry in ambient air.

In a final step 990, the operator screws lid 812 onto container 810 and stores the solution until its next use in accordance with the instructions, such as in a dark dry place. Additionally, the instructions may indicate that the solution has a longer shelf life if refrigerated between uses.

Alternatively, in step 990, the operator discards the solution in accordance with the instructions and MSDS, such as by pouring down a toilet and flushing the toilet.

Reference is now made to FIG. 10, which is an exploded schematic illustration of a kit 1000 for electrolytically plating monolayer on one or more large objects.

Kit 1000 differs from kit 800 in that a third container 930 is required and water, preferably distilled water/or another solvent solution, is added to container 1030 in addition to all/part of a first aqueous solution 1004—contents of a first container 1002 and all/part of a second aqueous solution 1022 from container 1020.

In an exemplary embodiment, kit 1000 comprises container 1002, holding the first aqueous solution and having a lid 1006 and an alphanumeric label 1008.

Container 1002 may or may not be substantially similar to container 1002 (FIG. 8A).

Additionally kit 1000, comprises the second container 1020 having lid 1024 and alphanumeric label 1026. Second container 1020 may or may not be substantially similar to container 810 (FIG. 8A).

Kit 1000 further comprises a large container or tank 1030 containing water 1032. Container 1030 has a lid 1034.

Lid 1034 typically comprises an aperture 1038, through which a holding rod 1036, acting as an anode may be held vertically. Holding rod 1036 typically has a loop 1040 at its lower end.

Alternatively, loop 1040 may be replaced by a clasp, clamp, peg or other holding device. Loop 1040 is used to hold large object 1044. Container 1030 typically has an alphanumeric label 1042.

The containers and lids of kit 1000 are typically of the same non-metallic materials as those described for corresponding parts in kit 800 (FIG. 8A).

Rod 1036 may be attached to a mechanical moving device, such as an eccentric motor (not shown).

In an alternative embodiment, rod 1036 may be replaced by a barrel, jig or other holder, known in the art of electrolytic and non-electrolytic metal plating. The barrel, jig or other holder may be manually or mechanically operated, as is known in the art.

Kit 1000 further comprises a power source or potentiostat 1050 in wired connection via wire 1053 with anode/rod 1036 and in wired connection 1051 with a cathode 1054.

Kit 1000 further contains an instruction sheet 1050, labeled with a number or letter 1054. Instruction sheet 1050 provides a simple user-friendly set of instructions 1052 on how to utilize the kit.

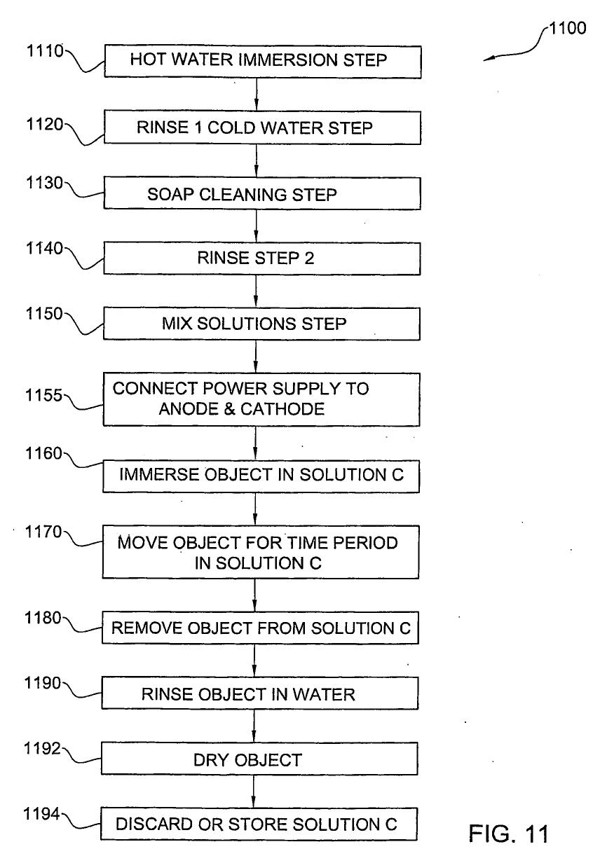

Reference is now made to FIG. 11, which is a flowchart 1100 describing the method of employment of kit 1000 of FIG. 10 in the steps of electrolytically plating monolayer on a large object.

Typically, large household silver objects require pretreatment, prior to monolayer deposition. For example, a candlestick would typically require that all wax be removed therefrom. Thus, flowchart 1100 describes four steps of pretreatment (steps 1110-1140) prior to the actual use of kit 1000. These steps may be eliminated or replaced by other pre-treatments, depending on the nature of the object and the condition of its surface. In industry, typical pre-treatments include alkaline hot soap dips, such as Top Alclean and solvent cleaning stages, as well as water rinses therebetween.

The operator typically reads and/or knows instructions 1052 on the instructions sheet 1050, prior to starting the process. The operator is typically acquainted with the MSDS (manufacturer's safety data sheet). Instructions 1052 comprise simple step-by-step directions on how to electrolytically plate one or more large objects with monolayer.

In a first pretreatment step 1110, the operator immerses object 1044 in hot water (40-100° C.) for several minutes to remove dust, dirt and large contaminants from the surface of the object.

In a second pretreatment step 1120, the operator manually rinses the object under running tap water.

In a third pretreatment step 1130, the operator immerses the object in a hot soapy solution (50-100° C., pH 8-10) in order to remove any further surface contaminants.

The operator then rinses object 1044 under running tap water in a fourth pretreatment step (rinse step 2) 1140.

In an exemplary embodiment and in accordance with the instructions, the operator fills container 1030 with a given volume of water/solvent. In a mixing step 1150, the operator pours the first solution 1004 from the first container 1002 into the liquid 1032 in container 1030 and mixes the resultant solution with rod 1036. The operator further pours the second liquid 1022 from second container 1020 into container 1030 and mixes the resultant solution with rod 1036.

In a connecting step 1155, the operator connects the power supply to the anode and to the cathode to complete the electrical circuit of system 1000. In some cases, this may be performed by connecting wire 1055 to anode/rod 1036 (the connections between power supply 1050 and cathode 1054 being permanently in place, in this embodiment).

In some embodiments, both the liquids 1004 (“A”) and 1022 (“B”), similar or identical to liquids “A” and “C” of FIG. 8A hereinabove, respectively, are used only for one plating process.

Alternatively, a proportion of liquid A (1004) and liquid B (1022) may be retained for one or more additional uses. For example, liquid B may be a replenisher solution comprising one or more of the components listed in Table 1 or 2 above at the same or at a higher concentration.

Container 1002 and container 1020 may comprise graduated markings for this purpose (not shown).

The ratio of liquid A to liquid C is normally well-defined and is constant for multiple usage. The final concentration of the resultant liquid in container 1030 is typically similar or identical to the compositions disclosed in Tables 1-2.

In an immersion step 110, the operator loads the object(s) into loop 1040 or onto/into an alternative fixture (peg, barrel, gig, tray sieve, netting) and immerses the loaded object(s) into mixed liquid “C” in container 1030. The operator may or may not place lid 1034 on container 1030.

The mixed liquid in container 1030 is typically at room temperature 20-30° C., though this process may also be operative at a temperature range of 0-50° C.

The pH of the mixed liquid is typically 9-11, but the solution is normally operative in a pH range of 8-13, though the reaction rate will vary.

In a deposition step, 1170, the operator may/may not move rod 1036 and hence loop 1040 holds object 1044 gently up and down and/or backwards and forwards for a time period. Alternatively, the object is moved by mechanical means.

In another alternative mode, the object is stationary during the deposition step. The time period is typically provided in the instructions as a fixed time at room temperature, such as ten minutes. Additionally or alternatively, the instructions may comprise a look-up table, which correlates the deposition time to the process temperature. Bubbles 1046 (typically of hydrogen) are indicative that object 1044 is being plated by the solution in container 1030.

Furthermore, the instructions may provide a rough guide or look-up table for the thickness of monolayer that is to be deposited as a function of the surface area of object 1044. For example, the surface area [cm²] of a goblet can be calculated to be approximately 4 hrₐᵥ, where rₐᵥ is the approximate average radius of the goblet and h is the height.

At the end of the given time period, the operator removes lid 1036 and further lifts rod 1036 vertically and disconnects rod 1036 from wire 1055, thus disconnecting the circuit and hence removing object 1044 from the solution in a removing step 1180.

Thereafter, in a rinsing step 1190, the operator rinses the object under running tap water. Additionally or alternatively, the rinsing step may comprise dipping the object in a container of water.

In a drying step 1192, the operator dries the object with a cloth. Alternatively, the operator leaves the object to dry in ambient air or under a directed hot-air flow.

In a final step 1194, the operator closes lid 1034 onto container 1030 and stores the solution until its next use in accordance with the instructions, such as in a dark dry place. Additionally, the instructions may indicate that the solution has a longer shelf-life if refrigerated between uses.

Alternatively, in step 1190, the operator discards the solution in accordance with the instructions and MSDS, such as by shipping out to a chemical waste disposal site.

It should be noted that though kits 800 and 1000 are described herein for the electrolytic plating monolayer, these types of kits may also be used for electrolytically plating monolayers onto any metal, metal alloy or metal combination (non-alloy), known in the art. This is with the provision, that the chemicals are not dangerous or toxic (cyanides), requiring the use of a fume cupboard. The electrolytic solutions preferably operate in a pH range of 3-11.

### EXAMPLES

The difference between novel thiolation procedures of this invention and known procedures may be understood from the examples below.

### Example 1

A silver or silver-coated article is first pre-cleaned in organic solvent or solvent mixture and aqueous basic solution containing anionic surfactant. After cleaning, the article is immersed in activation solution of diluted sulfuric acid and rinsed then in ethanol. Then, it is immediately transferred to thiolation solution containing ethanol as background medium, 0.1% by mass of octadecanethiol as thiol source, 10% by vol. of acetonitrile as polar solvent, 1% by mass of LiCiO₄ as electrolyte, and 0.1% by mass of nitrobenzoic acid as oxidizing agent. After 1 min exposure, the article is dip-rinsed in ethanol and allowed to dry to form a dense, low defect and high protection against metal corrosion film of thiol. A monolayer of silver octadecane thiolate is obtained on the article using this procedure.

### Example 2

An article is pre-cleaned and activated as in Example 1. Then it is connected to the positive pole of electric power supply. Another, negative pole of the supply is connected to a stainless steel strip immersed into electrochemical thiolation solution. The solution consists of ethanol as background medium, 0.1% by mass of octadecanethiol as thiol source, 10% by vol. of acetonitrile as polar solvent, and 1% by mass of LiClO₄ as electrolyte. The article is immersed into the thiolation solution for 1 min, the potential between electric power supply poles being held at 1.5V. It is removed then from the solution, dip-rinsed in ethanol and allowed to dry.

### Example 3

An article is pre-cleaned and activated as in Example 1. Then it is connected to the “working electrode” terminal of potentiostat. “Counter electrode” terminal of the potentiostat is connected and made of stainless steel strip immersed into electrochemical thiolation solution. The solution (electrolyte) is of the same composition as in Example 2. Reference electrode (Ag/AgCl in LiCl in acetonitrile) is immersed to the same solution and connected to a corresponding potentiostat terminal. The article is immersed into the thiolation solution for 1 min, and cycling of the electrode potential is activated between +0.5 and −0.5V with respect to a reference electrode, with a scan rate of 50 mV/sec. The process is finalized by potential holding at 0.5V for 10 sec.

### Example 4

Tests of discoloration resistance performance (indicative of corrosion resistance) of SAM and of monolayers formed under various conditions.

Polarization resistance, Rp, of coated with monolayer metal plates was calculated as ΔE/Δi, where E stands for electrode potential and i—for current density, from experiments with slow (2 mV/s) potential cycling in vicinity (+/−10 mV) of open circuit potential in 0.1M KCl solution. High Rp values were interpreted as indicative of high extent of metal surface passivation with SAM, that is, high monolayer performance as corrosion protector. Another test was cyclic voltammetry (CV) of 0.1M Fe(CN)₆⁴⁺/Fe(CN)₆³⁺ 1M KCl system where peak current height, Ip, was interpreted as indicative of pinhole and similar defect availability in the monolayer deposited. Finally, direct corrosion tests were made in wet atmosphere which contained increased concentration of H₂S. In latter tests, the monolayer protective power was evaluated by coating with monolayer metal plate ability to resist against discoloration in time, τ. As a criterion, the mean reflection dropped by more than 50% in light wavelength range from 400 to 700 nm that was taken as an indication of higher corrosion resistance (so that τ is interpreted further also as rated discoloration time—the longer the time the less discoloration).

TABLE 3
Test results for thiol SAMs prepared using different techniques. Every set of
three values provided in the table cells corresponds to the following range of
thiolation durations: 1; 6; and 30 min.

| | Description of conditions for SAM/ | | | |
|---|---|---|---|---|
| No. | monolayer deposition | Rₚ, kOhm · cm² | Iₚ, mkA/cm² | τ, hr |
| 1 | Not protected Ag (blank exp.) | 0.1 | 200 | 0.5 |
| 2 | Thiol SAM from fresh solution | 1; 2.5; 4 | 5; 3; 2 | 2; 6; 12 |
| 3 | Thiol SAM from degassed solution | 0.15; 0.5; 1.5 | 120; 60; 35 | 0.5; 1; 2 |
| 4 | Thiol SAM from aerated solution | 3; 6; 10 | 2; 1; 0.5 | 4; 8; 16 |
| 5 | Thiol monolayer from solution with | 1; 1.5; 3 | 5; 3; 1.5 | 2; 6; 12 |
| | oxidizing agent iodine | | | |
| 6 | Thiol monolayer from solution with | 5; 8; 12 | 1.5; 1; 0.6 | 6; 10; 18 |
| | oxidizing agent nitrobenzoic acid | | | |
| | (Example 1) | | | |
| 7 | Thiol monolayer from solution with | 8; 12; 16 | 1; 0.6; 0.3 | 12; 16; 20 |
| | oxidizing agent cerium(IV) sulfate | | | |
| 8 | Thiol monolayer on sample immersed/ | 0.1; 0.1; 0.1 | 180; 150; 150 | 0.5; 0.5; |
| | removed at E = −0.4 V | | | 0.5 |
| 9 | Thiol monolayer on sample immersed/ | 8; 10; 12 | 1.2; 0.8; 0.5 | 8; 12; 16 |
| | removed at E = 0.5 V | | | |
| | (Example 2) | | | |
| 10 | Thiol monolayer on sample immersed/ | 18; 24; 24 | 0.35; 0.25; 0.25 | 24; 32; 32 |
| | removed at E = 0.4 V | | | |
| 11 | Thiol monolayer on sample immersed/ | 25; 25; 25 | 0.15; 0.12; | 40; 40; 40 |
| | removed at E = 0.8 V | | 0.08 | |
| 12 | Thiol monolayer on sample immersed/ | 0.2; 0.2; 0.2 | 230; 260; 350 | 0.5; 0.5; |
| | removed at E = 1.2 V | | | 0.5 |
| 13 | Thiol monolayer on sample cycled during | 44; 48; 48 | 0.05; 0.05; | 64; 64; 64 |
| | deposition (Example 3) | | 0.05 | |
| 14 | Thiol monolayer on sample cycled after | 32; 36; 32 | 0.09; 0.11; | 48; 48; 48 |
| | deposition | | 0.08 | |
| 15 | Samples treated in MBTA | 1.5; 3; 5 | 4; 2.5; 1.5 | 2; 5; 8 |
| 16 | Samples chromatized cathodically | 8; 15; 25 | 25; 12; 9 | 5; 20; 32 |

Standard solution for thiol-monolayer preparation was 1 mM octadecanethiol in absolute ethanol. For electrochemical control of thiolation process, the solvent was composed of 50% of ethanol and 50% of acetonitrile (by vol.), to which 50 mM of LiClO₄ as electrolyte was added. Electrode potentials were measured with respect to Ag/0.1M AgNO₃ in acetonitrile reference electrode. Potential window in experiments with potential cycling was from −0.4 to 1 V and potential ramp rate was 100 mV/sec. Mercaptobenzothiazole (MBTA) based SAMs and chromatization films were made with a goal to give a reference with known methods of metal protection against corrosion. MBTA was 1% solution in 0.1M NaOH. Chromatization was made in 100 g/l Na₂CrO₄ solution neutralized with Na₂CO₃ to pH 8.5, cathode current density being 10 mA/cm².

One may conclude that all three characteristics chosen for monolayer defectlessness and protective power characterization are in good consistency. The higher its polarization resistance, the lower its peak current in CV measurements and the longer its discoloration time. To support our evidences, we conducted also the measurements (corresponding results are not cited in present document) of in situ electrochemical impedance (for double layer capacity and electrochemical reaction resistance) and quartz crystal micro-balance response (for monolayer deposition rate) for the growing monolayer and found them also being in good agreement with the results of main 3 characterizations above.

Some results may be summarized as follows:

1. Degassed and not containing special oxidizing agent solution does not provide effective SAM within at least 30 min exposure to thiolation solution.

2. Oxygen containing solution provides much more effective SAMs, and saturated with air solution accelerates effective SAM formation, obviously, due to oxidizing agent (oxygen) presence. However, to achieve the best results with aerated solutions, exposure time not shorter than 30 min is needed.

3. The results achievable from oxygenated solutions may considerably be improved when using special oxidizers such as nitrobenzoic acid or, yet better, cerium (IV) sulfate. Not every oxidizer enables monolayer-based protection improvement in comparison with oxygen-promoted SAM deposition. An appropriate oxidizer should have suitable own red-ox potential and facile electrochemical reduction kinetics on protected metal electrode (corresponding data are not cited in this document). If these requirements are met, highly protective monolayers are achieved within just 5 min of the sample exposure to thiolation solution.

4. Yet better results than those obtained with effective oxidizing agents are achieved under electrochemically controlled conditions when potential of the monolayer-treated electrode is held at specified optimal value. In case potential is too low or too high, no monolayer deposition occurs at all.

5. Properly chosen potential enables superior monolayer densification, unachievable in simply aerated or containing a special oxidizing agent thiolation solutions.

6. The best results however are achieved in conditions where potential of coated with monolayer metal electrode is cycled within properly chosen potential range.

Most important in the results submitted are those of the rated discoloration time. Corresponding data directly show that corrosion preventing power of thiol-based monolayers is dramatically improved via using of proper oxidizing agent in comparison with the process conducted in occasionally aerated solution and that yet better corrosion prevention is achieved when using electrochemical techniques such as monolayer deposition under controlled potential or, yet better, monolayer deposition in potential cycling conditions. Other data, namely those on Rₚ and Iₚ are also of importance because they show that the improvement in monolayer protection power is achieved owing to elimination of monolayer defects, which was ensured by application of said electrochemical techniques. The latter techniques have been designed owing to a deeper insight into essence of the process of thiol-like monolayer formation on metals, which is rooted, without wishing to be bound by theory, in electrochemistry and which was not realized consistently before.

The monolayer formation acceleration and the monolayer structure healing from defects when using (1) effective oxidizing agent (instead of dissolved oxygen), (2) specified potential application, and (3) electrode potential cycling within specified potential range in the following way.

Oxygen that is present occasionally in thiolation solution is not a best choice for oxidizing agent needed in the process. O₂ solubility (from air) in water in ambient conditions is about 0.35 mmol/l and is yet smaller for ethanol. This does not provide fast diffusion of depolarizer species to SAM-free sites and retards monolayer formation. More soluble oxidizer allows one to overcome this limitation. Besides, O₂ reduction kinetics is too slow and, thereby, is not capable of supporting sufficiently positive electrode mixed potential, at which effective chemisorption of the monolayer precursor molecules occurs. Appreciably high electrode positive potential is needed in order to make metal outer layer sufficiently positively charged and electron depleted. This promotes maximally strong covalent interaction between said metal atoms and the atoms of monolayer molecule head-groups. The optimal potential may be reached by precise selecting of oxidizer or, in most radical manner, by direct external electrochemical control.

The best solution for rapid and dense monolayer formation is associated with conditions when no reaction except for the main one (2) takes place on the coated surface so that said main reaction does not experience, simply spatially, any interference from the other (coupled) reaction side. This again is achievable only through external control of the electrode potential. The latter provides the optimal metal surface charging, making the entire electrode surface equally available for oxidative adsorption reaction (2) and resulting in maximal bond strength between metal and monolayer molecules.

Rate of monolayer formation under potential control is now determined by potential value and diffusion rate of the monolayer precursor molecule. Potential cycling allows the transfer of bound to metal surface monolayer molecules to oscillation regime, enabling molecule surface diffusion, better molecule fitting to metal surface energy landscape and also better monolayer molecule fitting to each other in inter-molecular lateral interaction, altogether leading to defectless, maximally relaxed structure obtaining.

1.-73. (canceled)

74. A method for deposition of a monolayer on a metallic surface, the method comprising:
providing a metallic surface;
contacting said metallic surface with a solution comprising (i) at least one organic compound having a surface-active group, and (ii) at least one non-gaseous oxidizing agent; and
applying potential to said surface being in contact with said solution;
whereby the at least one organic compound adsorbs onto the metallic surface to provide a monolayer-coated surface having high surface passivation.

75. The method according to claim 74, wherein said monolayer-coated surface having high surface passivation is characterized by at least one of (i) a high polarization resistance, Rp; (ii) a low pinhole density (availability), defined via peak current, Ip, in CV measurements; and (iii) a drop in the light mean reflection of surface at a wavelength between 400 and 700 nm.

76. The method according to claim 74, wherein said monolayer-coated surface comprising at least one of (i) Rp selected from at least 5 kOhm·cm², at least 8 kOhm·cm², and at least 15 kOhm·cm²; (ii) Ip selected from less than 1.5 mA/cm², less than 0.5 mA/cm², and less than 0.1 mA/cm²; and (iii) a drop in the mean reflection of the coated surface at a wavelength between 400 and 700 nm of at least 50% over a period of at least 50 hours.

77. The method according to claim 74, wherein the potential induced on the surface is a positive potential relative to a standard hydrogen electrode potential.

78. The method according to claim 77, wherein the positive potential is of at least about +0.2V.

79. The method according to claim 74, wherein the surface to be coated is a surface of an article, an object, an apparatus, an electrical appliance, a medical device, an optical object, a coin, a medal, an ornamental object, a piece of jewelry, a household appliance, and a military device.

80. The method according to claim 79, wherein said surface is of at least one metal, or an alloy thereof, or an oxide thereof, said metal being selected from copper, palladium, platinum, gold and silver, an alloy, oxide or a mixture thereof.

81. The method according to claim 80, wherein said surface is made of silver, an alloy, or an oxide thereof.

82. The method according to claim 74, wherein said at least one organic compound is a linear compound having at least one surface-active group at one of the termini of the linear chain.

83. The method according to claim 82, wherein said at least one surface-active group is selected amongst atoms or groups of atoms having preferential reactivity (adsorptive) towards the surface.

84. The method according to claim 82, wherein said at least one organic group is of the general formula HnER, wherein:
E is a reactive atom or a group of atoms;
R is an organic moiety selected from C5-C30-alkyl, and C6-C10-aryl, and
n is an integer from 1 to 3.

85. The method according to claim 84, wherein E is an atom selected from oxygen, sulfur, selenium, phosphorus and nitrogen.

86. The method according to claim 84, wherein E is a carboxylic acid or a carboxylate.

87. The method according to claim 84, wherein the compound of the general formula HnER is a compound of the formula HSR, wherein R is selected amongst C5-C30-alkyl, and C6-C10-aryl, each being optionally substituted.

88. The method according to claim 84, wherein R is of the formula HnE-(CH2)m-CH3, wherein n and E are as defined and m is an integer being at least 4.

89. The method according to claim 88, wherein the compound of the formula HnE-(CH2)m-CH3 is octadecanethiol, (HS—C18H37).

90. The method according to claim 74, wherein said non-gaseous oxidizing agent is selected from ammonium peroxosulfate, iodine, cerium (IV) sulfate and nitrobenzoic acid.

91. The method according to claim 74, wherein said solution comprising the at least one organic compound and the at least one non-gaseous oxidizing agent is an aqueous solution or a non-aqueous solution.

92. An object coated with a layer according to claim 74.

93. A formulation for electrodeposition of organic monolayer on a surface of an object, said composition comprising
(i) at least one organic compound of the general formula HnER, wherein:
E is a reactive atom or a group of atoms;
R is an organic moiety selected from C5-C30-alkyl, and C6-C10-aryl, and n is an integer from 1 to 3,
(ii) at least one non-gaseous oxidizing agent; and
(iii) at least one solvent.

94. A tarnish-resistant coated metallic object including; a metallic object, a organic monolayer coating on at least a part of a surface of the object, wherein the metallic object has a substantially constant reflectivity of more than 90% at 500 nm after exposure of the coated object to ambient air for a time period of at least one week.

95. The tarnish-resistant coated object according to claim 94, being selected from an article, an apparatus, a medical device, an optical object, a coin, a medal, an ornamental object, a piece of jewelry, a household appliance, and a military device.

96. The tarnish-resistant coated object according to claim 95, containing sterling silver or may include silver plate.

97. The tarnish-resistant coated object according to claim 96, wherein said silver is fine silver (100% silver).

98. The tarnish-resistant coated object according to claim 94, wherein the monolayer coating at least a part of a surface of the object is deposited thereon by:
providing a metallic surface;
contacting said metallic surface with a solution comprising (i) at least one organic compound having a surface-active group, and (ii) at least one non-gaseous oxidizing agent; and
applying potential to said surface being in contact with said solution;
whereby the at least one organic compound adsorbs onto the metallic surface to provide a monolayer-coated surface having high surface passivation.

99. A coated piece of jewelry including: a piece of jewelry; and an organic monolayer coating on at least part of a surface of the piece of jewelry, wherein the monolayer coating is adapted to prevent discoloration of the piece of jewelry after exposure of the coated piece of jewelry to ambient air for a time period of at least one week.

100. The coated piece of jewelry according to claim 99, comprising silver.

101. The coated piece of jewelry according to claim 100, wherein said silver includes silver plate.

102. The coated piece of jewelry according to claim 100, wherein said silver is fine silver (100% silver).
